(19) United States
(12) Patent Application Publication
(10) Pub. No.: US 2008/0160148 A1
(43) Pub. Date: Jul. 3, 2008

(54) See-through surface for rolling dough

(76) Inventors: Guy Dodelson, Kfar Saba (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 11/645,896

(22) Filed: Dec. 28, 2006

(51) Int. Cl. A21D 8/08

(52) U.S. Cl. 426/496; 428/446

(57) ABSTRACT

A transparent or semi-transparent flexible surface for rolling dough, using a method to avoid dough sticking to the surface and to the rolling pin. Measurements marked on the surface to assist rolling the dough to the desired size and shape. Ability to turn the rolled dough over without it breaking. Suitable for thin and delicate doughs.

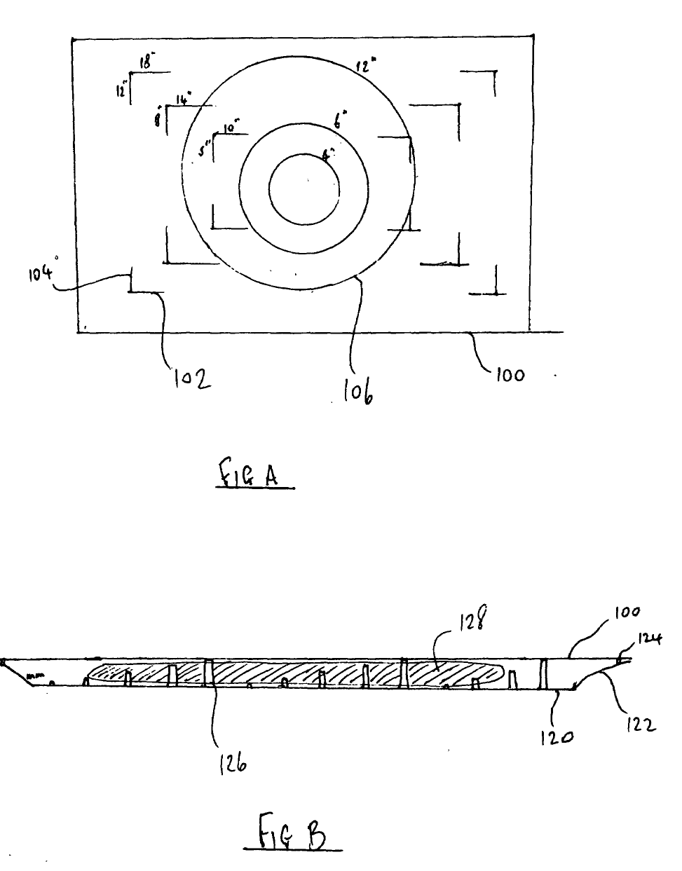

### FIELD OF THE INVENTION

This invention is in the field of pastry making and more particularly the surface upon which the pastry rests while being rolled.

### BACKGROUND OF THE INVENTION

The conventional method of rolling pastry requires the dough to be placed on a hard smooth surface and a rolling pin is pressed onto the dough while being rolled back and forth. A rolling pin is any cylindrical smooth surfaced object that can be conveniently used to press on the dough while rolling back and forth. The main object of the said rolling with pressure is to change the shape of the dough from the random shape it has after water is mixed with flour, to a smooth thin flat shape. The degree of thinness and the exact shape varies depending on the end product required.

Another object of the said rolling process is to better mix the ingredients of the dough before the baking process. Sometimes, as in the case of flaky pastry, the rolling process also helps to fold-in the fatty ingredients into the dough mixture.

The main disadvantage of this method of rolling the dough is that the dough often sticks to the rolling pin and to the surface upon which the dough is being rolled. The stuck dough causes more dough to stick to the said pin and to the said surface because dough more easily sticks to itself than a clean smooth surface. The result is that the person desiring to roll the dough wastes a lot of his time, cleaning the bits of dough off the said pin and off the said surface. This cleaning is effective for only short time before the dough starts sticking again. Various methods of preventing this sticking of the dough have been used. Some of them are mentioned here. Flour can be sprinkled on the said surface and on the said pin. This has the effect of temporarily reducing the sticking effect but is only temporary and has a drying effect on the dough which can be a negative factor where the consistency of the dough is required to be moist. Another method of preventing the sticking of the dough is to smear a thin layer of oil on the said surface and said pin. This method also has a temporary effect and increases the oily consistency of the dough which is not usually desirable. What is required is a method of rolling the dough to the required thinness with a minimum of dough sticking to the contact surfaces.

There are types of dough that it is necessary to see the reverse side of the dough during the rolling process to examine consistency, shape and size. With present art the dough has to be turned upside down to examine it and this often causes the dough to break or fold over and stick to itself resulting in damage to the dough and loss of time. In addition it is desirable for there to be a convenient method of measuring the size of the dough that has been rolled. Sometimes it will be too narrow or too short for the baking pan. After the thin layer of rolled dough has been taken off the rolling surface to be placed carefully on the baking pan or tray, and then is found to be too short or too narrow, it is very hard to return the dough to the said rolling surface without damaging it. Many times repair work needs to be done or the dough needs to be rolled again. This wastes time and can damage the quality of the dough when it is re-rolled.

There is a need therefore, for a method of measuring the length and width of the rolled dough before it leaves the rolling surface. Where circular dough is required, there is a need to measure the diameter of the circle. While still on the rolling surface changes to the dough can be more easily effected, causing minimum damage to the quality and consistency of the dough.

Another need for dough rollers is to clearly see both sides of the dough they are rolling and easy transfer of the dough or similar substances, like carpucio, to the preferred serving tray.

Another need is for there to be a greater degree of cleanliness in the dough making process. This will have a positive effect on the hygienic aspect of baking as well as the pleasure of working with clean apparatus.

A dough rolling surface that can combine these functions of reduced dough sticking, visibility on both sides of the dough during the rolling process and aiding dough measurement of shape and size will assist those involved in dough rolling.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

An object of this invention is to provide as near as possible a stick free surface to roll or press dough into a thin sheet of dough without interfering with the ability to shape the dough into whatever shape is desired.

Another object of this invention is to enable working with the dough making tools without the same having dough stuck to them. The clean working environment increases hygiene and the pleasure of working with dough.

Another object of this invention is to enable the shaping of other kinds of foods while being able to examine the underside with ease for example, sheets of chocolate, caramel products or carpucio.

Another object of this invention is to enable the examination of the reverse side of the dough during the rolling process without damaging the dough.

Another object of this invention is to enable the measurement the area of rolled dough accurately and without damaging the dough.

Another object of this invention is to enable the continuation of the rolling process after the said examination on both sides of the dough and/or the said measuring.

Another object of this invention is to be able to remove the dough from the stick free surface of this invention and be able to transfer even very thin sheets of dough.

These above mentioned objects are achieved by using two layers of a smooth flexible surface like a silicon sheet. The bottom layer could be a little thicker for stability and the upper silicon sheet could be thinner to allow more flexibility. The dough would be placed in between these two silicon sheets and the roller is rolled on top of the top sheet. Both the silicon sheets would be transparent to allow clear vision of the dough being rolled. The dough could be easily turned upside down to examine the reverse side and either rolled on the reverse side on turned back to the original side to continue rolling. Either way the dough will not be damaged from such reverse side examination.

Additionally there could be markings on one or both of the silicon sheets indicating sizes and shapes of different sizes to aid the dough roller produce the dough close to the correct consistency, shape and size.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. A is a schematic depiction of a silicon dough-rolling surface from the top view, showing measurement markings.

FIG. B is a schematic depiction of a silicon dough-rolling surface from the side view, showing dough sandwiched between two silicon surfaces.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

FIG. A shows the dough-rolling surface 100 made of a special kind of silicon that is smooth and flexible. This minimizes dough sticking to its surface. On the surface are markings of measurements showing a number of lengths 102 and a number of widths 104 so that the majority of regular sizes are marked. Likewise, a number of circular shapes 106 are marked with the dimensions shown indicating the diameter of the circles.

As will be described below in relation to FIG. B, one of the embodiments of this invention is to turn the rolling surface 100 upside down and therefore the said markings of lengths, widths and circles can be read also on the underside of the said surface 100 where both the top and bottom layer of silicon sheeting have these said measurement markings.

FIG. B shows the side view of two silicon surfaces. They started by the surface 100 being the bottom layer resting on a table. The dough 128 was placed on the surface 100 and the second layer of silicon sheet 120 placed on top of the dough 128.

The dough 128 is then rolled by pressing with the rolling pin on top of the top layer of silicon 120. This firstly has the immediate advantage that the dough 128 does not stick to the surface of the rolling pin. Secondly the person rolling can see through the silicon sheet 120 to see how the rolling process is progressing. Thirdly he can measure the size of the dough 128 as the rolling process expands the size of the dough 128, using the measurement markings FIG. A 102, 104 and 106 that are on both said sheets of silicon.

After some time rolling the dough 128, it would be prudent to examine the reverse size of the dough 128 without damaging the work so far achieved by the said rolling. This is done by holding the dough between the two layers of silicon 100 and 120 and turning it upside down so that surface 100 is on top and surface 120 is underneath. There could be a clip 124 or other device to hold the two silicon surfaces together.

The measurement markings on sheet 100 will enable easy comparison of the current size of the dough 128 against the required size. The dough can be rolled when in this reversed position or reversed again to its original position and then easily removed by peeling and placing upside down on the required surface.

What is claimed is:

1. A method and device for rolling dough comprising
a lower layer of flexible non-stick transparent material,
an upper layer of flexible non-stick transparent material,
a means to join the said lower layer to the said upper layer,
whereby dough can be rolled without sticking to the roller and the reverse side of the dough can be examined and rolled during the rolling process with minimal damage to the said dough.

2. A method and device as claimed in claim 1 wherein
the said material is silicon.

3. A method and device as claimed in claim 1 wherein
the said transparency is partial.

4. A method and device as claimed in claim 1 wherein
the two said layers of transparent material has a detachable means hold together the two said layers with the said dough between them to facilitate turning the said dough upside down.

5. A method and device as claimed in claim 1 wherein
the said means to join the said upper and lower layers is with a hinge so that the two said layers can be opened and closed pivoted at the hinge.

6. A method and device as claimed in claim 1 wherein
the said transparent material is marked with lines indicating lengths, widths and circular measurements.

7. A method and device as claimed in claim 1 further comprising a means to measure the thickness of the said dough.

8. A method and device as claimed in claim 1 wherein
the said dough is easily peeled from the said non-stick material causing minimal damage to the rolled dough.

9. A method and device for rolling dough comprising
a lower layer of flexible non-stick transparent material,
an upper layer of flexible non-stick transparent material,
a means to join the said lower layer and said upper layer,
measurement markings on the said material,
a means to measure the thickness of the said dough,
whereby dough can be rolled without sticking to the roller, the reverse side of the dough can be examined and rolled during the rolling process with minimal damage to the said dough and the size of the said dough can be compared with the said measurement markings.

10. A method and device as claimed in claim 9 wherein
the said material is silicon.

11. A method and device as claimed in claim 9 wherein
the said transparency is partial.

12. A method and device as claimed in claim 9 wherein
the two layers of said transparent material has a detachable means hold together the two said layers with the said dough between them to facilitate turning the said dough upside down.

13. A method and device as claimed in claim 9 wherein
the said means to join the said upper and lower layers is with a hinge so that the two said layers can be opened and closed pivoted at the hinge

14. A method and device as claimed in claim 9 wherein
the said measurement markings are marked in or on the said material indicating lengths, widths and circular measurements.

15. A method and device as claimed in claim 9 wherein
the means to measure the thickness of the said dough is with flexible protrusions fixed on the said lower layer.

16. A method and device as claimed in claim 9 wherein
the means to measure the thickness of the said dough is with flexible protrusions fixed on the said upper layer.
